(19) United States
(12) Patent Application Publication
(10) Pub. No.: US 2024/0101433 A1
(43) Pub. Date: Mar. 28, 2024

(54) HIERARCHICAL POROUS MATERIAL FOR MOLECULAR SIEVE WITH MFI STRUCTURE AND PREPARATION METHOD THEREOF

(71) Applicants: Jilin University, Changchun City (CN); Shandong Hongtai Hengrui New Material Co., Ltd., Tai"an City (CN)

(72) Inventors: Tao Tian, Changchun City (CN); Dongdong Zhang, Changchun City (CN); Lei Wang, Changchun City (CN); Dianmin Ma, Changchun City (CN); Jiangang Sun, Changchun City (CN); Jitao Zhang, Changchun City (CN); Ming Zhang, Changchun City (CN)

(21) Appl. No.: 18/370,975

(22) Filed: Sep. 21, 2023

(30) Foreign Application Priority Data
Sep. 27, 2022 (CN) 202211178876.6

(51) Int. Cl. C01B 39/26

(52) U.S. Cl. CPC C01B 39/26

(57) ABSTRACT

The present disclosure discloses a method for preparing a hierarchical porous material for a molecular sieve with an MFI structure. In the present disclosure, porous silicon dioxide is used as a carrier on a surface of which a nano zeolite seed is loaded, and then subjected to treatment with a secondary growth compound fluid and hydrothermal crystallization, so that a nano zeolite molecular sieve membrane is further grown on the surface of the porous silicon dioxide. The specific surface area and pore volume of the hierarchical porous material for the molecular sieve with the MFI structure prepared by the present disclosure are greatly improved compared with those of the original porous silicon dioxide. The material not only has the macroporous structure of the porous silicon dioxide, but also incorporates micropores of the molecular sieve itself and mesopores formed by molecular sieve agglomeration.

### CROSS REFERENCE TO RELATED APPLICATION

This application claims takes priority from and claims the benefit of Chinese Patent Application No. 202211178876.6 filed on Sep. 27, 2022, the contents of which are herein incorporated by reference.

### TECHNICAL FIELD

The present disclosure belongs to the field of molecular sieves, and particularly relates to a hierarchical porous material for a molecular sieve with an MFI (Mordenite Framework Inverted) structure and a preparation method thereof.

### BACKGROUND

A ZSM-5 molecular sieve is a more commonly used molecular sieve among molecular sieves with an MFI pore channel structure. It belongs to a tetragonal system and has a framework density of 17.9/1,000 angstroms. The basic building block of it is a five-membered ring composed of a silicon-oxygen tetrahedron and an aluminum-oxygen tetrahedron. 8 five-membered rings are connected with each other through a T-O-T bond as an oxo bridge, and then enclosed into a molecular sieve framework. A main pore channel of it is a ten-membered ring, which has two types, one is a straight pore channel of the ten-membered ring (5.1×5.5 nm) parallel to a b axis, and the other is a Zigzag-shaped pore channel of the ten-membered ring (5.3×5.6 nm) parallel to an a axis. A diameter at an intersection of the two types of pore channels is 0.9 nm and a corner is 150°. A silicon-aluminum ratio in a crystal cell can be adjusted in a very wide range, which can vary from silicon-enriched to full silicon. In the ZSM-5 molecular sieve, a Lewis acid is derived from tri-coordinated aluminum, and the tri-coordinated aluminum in the framework has a vacant orbital and thus can accept an electron pair; and a Brønsted acid is derived from tetra-coordinated aluminum. The tetra-coordinated framework aluminum building block carries one positive charge, and its oxo bridge bond carries one proton. With the increase of the silicon-aluminum ratio of the ZSM-5 molecular sieve, the content of the aluminum element in the framework decreases, the acid content of the molecular sieve decreases, and the acid strength increases. Moreover, the change of the silicon-aluminum ratio affects the hydrophilicity of the molecular sieve and changes a suitable system in which it is applied. When all the aluminum in the crystal cell is replaced by silicon, it is a Silicalite-1 molecular sieve.

The ZSM-5 molecular sieve has many excellent properties. For example, ZSM-5 has an appropriate pore size, good type selectivity for various reactions, good thermal stability and hydrothermal stability of the skeleton, and strong anti-carbon deposition capability. Because of its special structural properties, it is widely applied in aspects such as petroleum refining, fine chemicals and the generation of intermediate products. At the same time, the ZSM-5 has a three-dimensional microporous topological structure with developed and regular pore channels and a large specific surface area, so it has more reactive sites, can be used for ion exchange and as a material for adsorption separation. Also, because of its good ion exchange performance and anti-carbon deposition performance, it has very good activity and selectivity for low-carbon olefins and aromatics. The ZSM-5 and full-silicon Silicalite-1 molecular sieves are widely applied in type-selective catalysis, organic adsorption, petroleum cracking catalysis and the like fields because of their regular pore channel structures, very strong ion exchange capability, large specific surface areas and good thermal stability.

### SUMMARY

An objective of the present disclosure is to provide a method for preparing a hierarchical porous material for a molecular sieve with an MFI structure. This method has short production time and low production cost and is of great significance to industrial production.

According to specific embodiments of the present disclosure, a method for preparing a hierarchical porous material for a molecular sieve with an MFI structure includes the following steps:
(1) synthesis of a molecular sieve seed:
(1-1) adding tetrapropylammonium hydroxide into water, stirring, then adding ethyl orthosilicate, stirring, and reacting at 90-110° C. for 3-5 days, wherein the molar ratio of the ethyl orthosilicate, the tetrapropylammonium hydroxide and the water is (20-30):(5-13):(450-510); and
(1-2) cleaning a reactant obtained in the step (1-1), oven-drying and grinding to obtain a molecular sieve seed; and
(2) compounding:
(2-1) adding porous silicon dioxide into a polycationic electrolyte solution with a concentration of 0.5 wt %, stirring and allowing to stand; washing with water for 3-4 times, and centrifugally separating after each times of washing, so as to obtain a porous silicon dioxide solution;
(2-2) adding the molecular sieve seed into an ammonia water solution with a pH of 9.5 to formulate a zeolite-ammonia water sol of 0.25 wt %-1 wt %, adding the porous silicon dioxide solution obtained in the step (2-1), stirring, and then allowing to stand; washing for 3-4 times, centrifugally separating after each times of washing, so as to obtain a carrier preloaded with the seed;
(2-3) formulating a secondary growth solution with a Al₂(SO₄)₃:SiO₂:NaOH:H₂O molar ratio of (0.03-2.50):100:(48-56):4,000, adding the carrier preloaded with the seed obtained in the step (2-2), stirring, putting into a reaction kettle, crystallizing at 180-220° C. for 3-8 h, cooling to normal temperature after the crystallization is ended, and filtering to obtain a precipitated product; and
(2-4) washing the precipitated product with water, and drying and roasting the product to obtain the hierarchical porous material for the molecular sieve with the MFI structure.

For the method for preparing a hierarchical porous material for a molecular sieve with an MFI structure according to specific embodiments of the present disclosure, in the step (2-1), a concentration of the porous silicon dioxide solution is 4-6 g/ml.

For the method for preparing a hierarchical porous material for a molecular sieve with an MFI structure according to specific embodiments of the present disclosure, in the step (2-3), a proportion of the carrier preloaded with the seed to the secondary growth solution is 3-5 wt %, and preferably, the proportion of the carrier preloaded with the seed to the secondary growth solution is.

For the method for preparing a hierarchical porous material for a molecular sieve with an MFI structure according to specific embodiments of the present disclosure, in the step (2-1), the polycationic electrolyte solution is an aqueous solution of polydiallyldimethylammonium chloride.

For the method for preparing a hierarchical porous material for a molecular sieve with an MFI structure according to specific embodiments of the present disclosure, specific steps of the step (1-2) are:
centrifugally separating the reactant obtained in the step (1-1), discarding the supernatant, continually adding deionized water into the remaining solid, centrifugally separating after ultrasonication, and discarding the supernatant; repeatedly washing until the pH of the supernatant is between 7-8, oven-drying the obtained solid at 60° C., and grinding to obtain the molecular sieve seed.

For the method for preparing a hierarchical porous material for a molecular sieve with an MFI structure according to specific embodiments of the present disclosure, specific steps of the step (2-4) are: washing the precipitated product with water for 3 times, drying at 80° C. for 24 h, and then roasting at 550° C. for 6 h to obtain the hierarchical porous material for the molecular sieve with the MFI structure.

For the method for preparing a hierarchical porous material for a molecular sieve with an MFI structure according to specific embodiments of the present disclosure, the SiO₂ (silica sol) is a ludox AS-40 silica sol.

For the method for preparing a hierarchical porous material for a molecular sieve with an MFI structure according to specific embodiments of the present disclosure, the Al₂(SO₄)₃ (aluminum source) is iron-free aluminum sulfate.

Specifically, the method for preparing a hierarchical porous material for a molecular sieve with an MFI structure of the present disclosure includes the following steps.
1. Synthesis of a seed:
(1) materials are weighed according to a molar ratio of ethyl orthosilicate, tetrapropylammonium hydroxide and water of (20-30):(5-13):(450-510), tetrapropylammonium hydroxide and water are added firstly, stirred for 0.5 h, and then added with ethyl orthosilicate. The mixture is stirred for 12 h, charged into a reaction kettle with a filling degree of 60%-80%, and reacted at 100° C. for 4 d.
(2) The product after the reaction is centrifugally separated, the supernatant is discarded, the remaining solid is continually added with deionized water, subjected to ultrasonication for 10 min and centrifugally separated, and the supernatant is discarded.
(3) The step (2) is repeated for 3-4 times until the pH of the supernatant is between 7-8, and the resultant solid is oven-dried at 60° C. and ground to obtain a molecular sieve seed.
2. Compounding:
(1) 20 ml of a polycationic electrolyte solution with a concentration of 0.5 wt % is taken, added with 1 g of porous silicon dioxide, stirred for 1 h, and allowed to stand for 30 min. It is washed with water for 3-4 time, and centrifugally separated after each time of washing.
(2) 0.02 g-0.2 g of the molecular sieve seed is weighed, added with 20 ml of an ammonia water solution with a pH of 9.5 to formulate a 0.25 wt %-1 wt % zeolite-ammonia water sol, which is added with the carrier subjected to the aforementioned treatment, stirred for 1 h, and allowed to stand for 30 min 250 ml of a 0.1 mol/L ammonia water solution is formulated as a washing liquid to wash for 3-4 times, and centrifugal separation is conducted after each time of washing.
(3) A secondary growth solution (m_{seed}/mSiO₂₋ₘᵢₓ=4 wt %) with a Al₂(SO₄)₃:SiO₂:NaOH:H₂O molar ratio of (0.03-2.50):100:(48-56):4,000 is formulated, wherein a sodium hydroxide solution is firstly added with aluminum sulfate, then added with a 40 wt % silica sol (a SiO₂ aqueous solution) and stirred for 15 min, subsequently added with the aforementioned carrier preloaded with the seed and stirred at room temperature for 3 h, put into a reaction kettle with a filling degree of 60%-70%, crystallized at 200° C. for 4 h, cooled to room temperature after the crystallization is ended, and filtered to obtain a precipitated product.
(4) The resultant product is washed with water for 3 times, dried at 80° C. for 24 h, and then roasted at 550° C. for 6 h, so as to obtain the hierarchical porous material for the molecular sieve with the MFI structure.

The present disclosure further provides a hierarchical porous material for a molecular sieve with an MFI structure prepared by the aforementioned preparation method.

The present disclosure has the following beneficial effects:
(1) the porous silicon dioxide is modified by treating with the polycationic electrolyte solution to make it positively charged, so that it is better combined with the negatively charged zeolite molecular sieve seed modified by the ammonia water solution, thereby improving the loading rate of the molecular sieve;
(2) the specific surface area and pore volume of the porous silicon dioxide-based composite molecular sieve prepared by the method of the present disclosure are greatly improved compared with those of the porous silicon dioxide and the molecular sieve;
(3) the secondary growth solution in the present disclosure can obtain a highly crystallized composite molecular sieve in a short time without an additional organic template agent and a crystallization promoter, which greatly reduces the cost consumption brought about in the production process and can be applied to commercial production;
(4) the silica sol used in the present disclosure can be applicable to industrial grade, and compared with other organic silicon sources, TEOS is low in price, pollution-free, green and environment-friendly;
(5) a series of porous materials for a MFI molecular sieve with different silicon-aluminum ratios or even full silicon can be prepared by regulating the materials of silicon and aluminum sources in the molecular sieve growth solution; and
(6) the composite molecular sieve prepared by the present disclosure has good compatibility, can be regenerated, and can be used in combination with other processes.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show some embodiments of the present disclosure, and those of ordinary skills in the art may still derive other drawings from these accompanying drawings without creative efforts.

FIG. 1 is an X-ray diffraction pattern of ZSM-5 (Si/Al=50) composite molecular sieve at different crystallization times in an example.

FIGS. 2a-f is a scanning electron micrograph of a carrier, a seed and a ZSM-5 composite molecular sieve in an example.

FIG. 3 shows the N₂ adsorption-desorption isotherms of the carrier, the seed and the ZSM-5 composite molecular sieve in an example.

FIG. 4 is an X-ray diffraction pattern of the seed, the carrier and the ZSM-5 composite molecular sieve with different silicon-aluminum ratios in an example.

### DETAILED DESCRIPTION OF THE EMBODIMENTS

In order to make the objects, technical solutions and advantages of the present disclosure more clear, the technical solutions of the present disclosure will be described in detail below. Apparently, the described embodiments are merely a part rather than all of the embodiments of the present disclosure. All other embodiments obtained by those of ordinary skills in the art based on the embodiments of the present disclosure without creative efforts are within the claimed scope of the present disclosure.

### Example 1

1. Synthesis of a seed:
(1) into a beaker firstly added were ethyl orthosilicate, tetrapropylammonium hydroxide and water according to a molar ratio (25:9:480); it was firstly added with tetrapropylammonium hydroxide and water, stirred for 0.5 h, then added with ethyl orthosilicate, stirred for 12 h, put into a reaction kettle, and reacted at 100° C. for 4 d.
(2) The product after the reaction was centrifugally separated for about 10 min, the supernatant was discarded, the remaining solid was continually added with deionized water, subjected to ultrasonication for 10 min and centrifugally separated, and the supernatant was discarded. Washing was conducted in this way for 3-4 times until the pH of the supernatant was between 7-8, so as to obtain a solid as a seed. The solid could be oven-dried at 60° C. and ground.
2. Compounding:
(1) 2.5 ml of a 20 wt % polydiallyldimethylammonium chloride solution was taken and diluted into a 100 ml volumetric flask to formulate a 0.5 wt % solution. 20 ml of the solution was taken, added with 1 g of a silicon dioxide carrier, stirred for 1 h, and allowed to stand for 30 min. It was washed with water for 3-4 times, and centrifuged for 10 min after each time of washing to obtain a preloaded carrier;
(2) 0.05 g of the molecular sieve seed was weighed, added with 20 ml of an ammonia water solution with a pH of 9.5 to formulate a zeolite sol, added with the aforementioned carrier, stirred for 1 h, and allowed to stand for 30 min. 250 ml of a 0.1 mol/L ammonia water solution was formulated as a washing liquid to wash for 3-4 times, and centrifugation was conducted for 10 min after each time of washing.
(3) A secondary growth solution (m_{seed}/mSiO₂₋ₘᵢₓ=4 wt %) with a molar ratio of 1.0 Al₂(SO₄)₃:100 SiO₂:56 NaOH:4,000 H₂O was formulated, wherein a sodium hydroxide solution was firstly added with aluminum sulfate, then added with a silica sol (ludox AS-40) and stirred for 15 min, subsequently added with the aforementioned carrier preloaded with the seed, stirred at room temperature for 3 h, put into a kettle and crystallized at 200° C. for 2 h, 4 h, 8 h, 12 h and 24 h respectively, cooled to room temperature after the crystallization was ended, and filtered to obtain a precipitated product.
(4) The resultant product was washed with water for 3 times, dried at 80° C. for 24 h, and then roasted at 550° C. for 6 h, and the product was weighed.

In the present disclosure, the crystallization time was adjusted to 2 h, 8 h, 12 h and 24 h respectively, and the seed induction results were investigated.

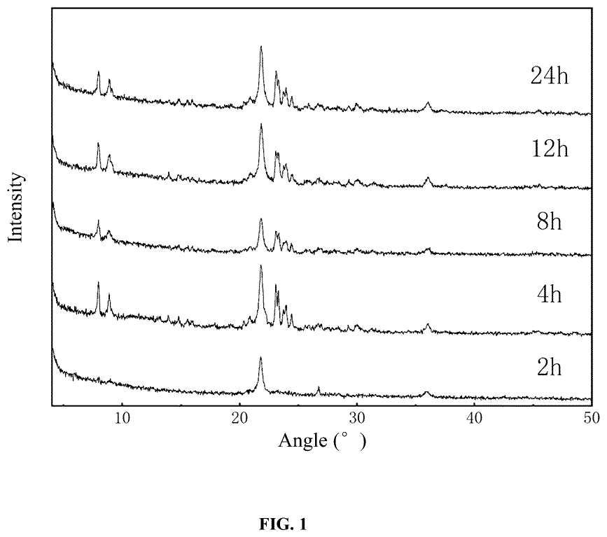

The results were as shown in FIG. 1, As could be seen from the X-ray diffraction pattern of the ZSM-5 composite molecular sieve, characteristic peaks centered at 20°-25° and 35°-37° occurred in all of composite ZSM-5 molecular sieves with crystallization times of 4 h, 8 h, 12 h and 24 h, and diffraction peaks with higher intensity occurred at about 8.2°, 9.1°, 23.4°, 24.3° and 24.8°, which indicated that under the aforementioned experimental conditions, the ZSM-5 composite molecular sieve was successfully synthesized by seed induction without a template agent. A well-crystallized ZSM-5 composite molecular sieve could be obtained just under a condition of a crystallization time of 4 hours, which could greatly improve the production efficiency.

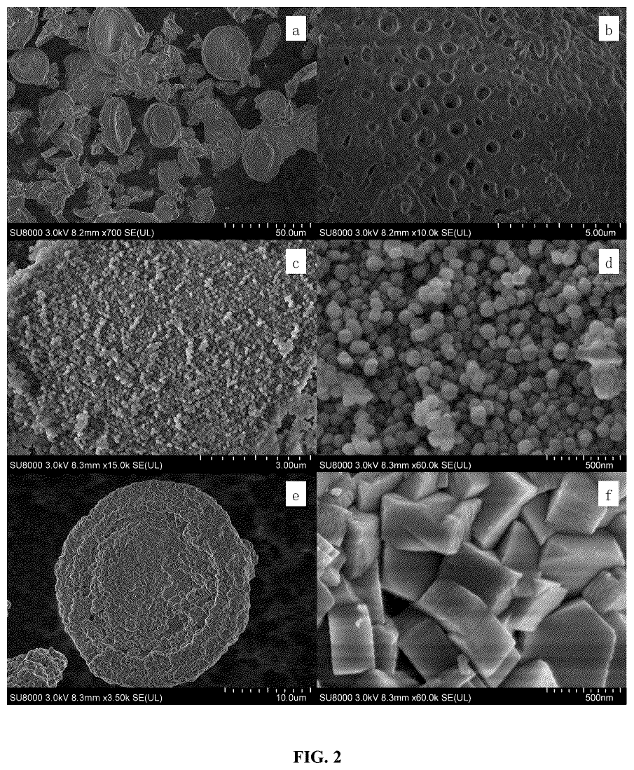

FIGS. 2(a, b), (c, d) and (e, f) were scanning electron micrographs of the carrier, the seed and the ZSM-5 composite molecular sieve, respectively. It could be seen from the figure that the porous silicon dioxide sample had a morphology of regular disc with a diameter of about 20 μm-25 μm, and macropores were densely distributed on the surface of the shell relatively evenly. The pore channel structure was relatively developed, and the pore size was approximately between 200 nm-600 nm. The seed molecular sieve of the present disclosure had uniform crystal grain distribution of about 70 nm-80 nm.

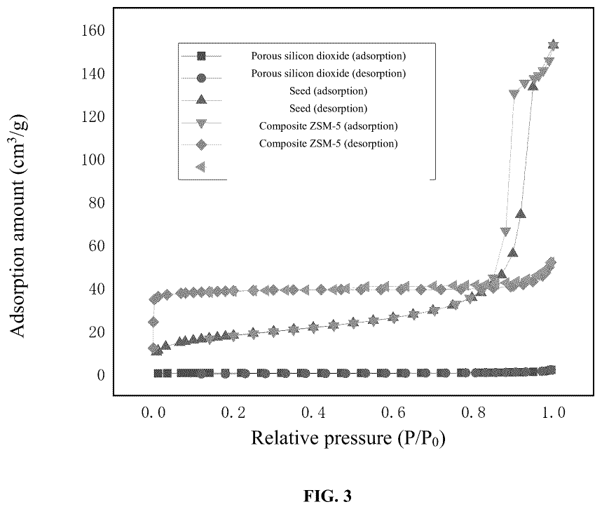

FIG. 3 was an isothermal diagram of nitrogen adsorption and desorption for the carrier, the seed and the composite ZSM-5 molecular sieve, wherein the carrier is the porous silicon dioxide carrier mentioned in the present disclosure, the seed was the molecular sieve seed synthesized as described in 1. Synthesis of a seed in Example 1, and the composite ZSM-5 molecular sieve was the composite molecular sieve material synthesized as described in Example 1. A BET surface area of the composite ZSM-5 molecular sieve as tested was up to 155.27 m²/g, which was much higher than those of the carrier (2.1 m²/g) and the seed (64.9 m²/g). The pore volume of the composite ZSM-5 molecular sieve was 0.08 cm 3/g, which was improved greatly compared with that of the carrier (0.003 cm 3/g).

### Example 2

1. Synthesis of a seed:
(1) into a beaker firstly added were ethyl orthosilicate, tetrapropylammonium hydroxide and water according to a molar ratio (25:9:480), wherein firstly tetrapropylammonium hydroxide and water were added, stirred for 0.5 h, and then added with ethyl orthosilicate. It was stirred for 12 h, put into a kettle, and reacted at 100° C. for 4 d.
(2) The product after the reaction was centrifugally separated for about 10 min, the supernatant was discarded, the remaining solid was continually added with deionized water, subjected to ultrasonication for 10 min and centrifugally separated, and the supernatant was discarded. Washing was conducted in this way for 3-4 times until the pH of the supernatant was between 7-8, so as to obtain a solid as a seed. The solid could be oven-dried at 60° C. and ground.
2. Compounding:
(1) 2.5 ml of a 20 wt % polydiallyldimethylammonium chloride solution was taken and diluted into a 100 ml volumetric flask to formulate a 0.5 wt % solution. 20 ml of the solution was taken, added with 1 g of a silicon dioxide carrier, stirred for 1 h, and allowed to stand for 30 min. It was washed with water for 3-4 times, and centrifuged for 10 min after each time of washing.
(2) 0.05 g of the molecular sieve seed was weighed, added with 20 ml of an ammonia water solution with a pH of 9.5 to formulate a zeolite sol, added with the aforementioned carrier, stirred for 1 h, and allowed to stand for 30 min. 250 ml of a 0.1 mol/L ammonia water solution was formulated as a washing liquid to wash for 3-4 times, and centrifugation was conducted for 10 min after each time of washing.
(3) A secondary growth solution (m_{seed}/mSiO₂₋ₘᵢₓ=4 wt %) with a molar ratio of 0.33 Al₂(SO₄)₃:100 SiO₂:56 NaOH:4,000 H₂O was formulated, wherein a sodium hydroxide solution was firstly added with aluminum sulfate, then added with a silica sol (ludox AS-40) and stirred for 15 min, subsequently added with the aforementioned carrier preloaded with the seed, stirred at room temperature for 3 h, put into a kettle and crystallized at 200° C. for 12 h, cooled to room temperature after the crystallization was ended, and filtered to obtain a precipitated product.
(4) The resultant product was washed with water for 3 times, dried at 80° C. for 24 h, and then roasted at 550° C. for 6 h, and the product was weighed.

### Example 3

1. Synthesis of a seed:
(1) into a beaker firstly added were ethyl orthosilicate, tetrapropylammonium hydroxide and water according to a molar ratio (25:9:480), wherein firstly tetrapropylammonium hydroxide and water were added, stirred for 0.5 h, and then added with ethyl orthosilicate. It was stirred for 12 h, put into a kettle, and reacted at 100° C. for 4 d.
(2) The product after the reaction was centrifugally separated for about 10 min, the supernatant was discarded, the remaining solid was continually added with deionized water, subjected to ultrasonication for 10 min and centrifugally separated, and the supernatant was discarded. Washing was conducted in this way for 3-4 times until the pH of the supernatant was between 7-8, so as to obtain a solid as a seed. The solid could be oven-dried at 60° C. and ground.
2. Compounding:
(1) 2.5 ml of a 20 wt % polydiallyldimethylammonium chloride solution was taken and diluted into a 100 ml volumetric flask to formulate a 0.5 wt % solution. 20 ml of the solution was taken, added with 1 g of a silicon dioxide carrier, stirred for 1 h, and allowed to stand for 30 min. It was washed with water for 3-4 times, and centrifuged for 10 min after each time of washing.
(2) 0.05 g of the molecular sieve seed was weighed, added with 20 ml of an ammonia water solution with a pH of 9.5 to formulate a zeolite sol, added with the aforementioned carrier, stirred for 1 h, and allowed to stand for 30 min. 250 ml of a 0.1 mol/L ammonia water solution was formulated as a washing liquid to wash for 3-4 times, and centrifugation was conducted for 10 min after each time of washing.
(3) A secondary growth solution (m_{seed}/mSiO₂₋ₘᵢₓ=4 wt %) with a molar ratio of 0.25 Al₂(SO₄)₃:100 SiO₂:56 NaOH:4,000 H₂O was formulated, wherein a sodium hydroxide solution was firstly added with aluminum sulfate, then added with a silica sol (ludox AS-40) and stirred for 15 min, subsequently added with the aforementioned carrier preloaded with the seed, stirred at room temperature for 3 h, put into a kettle and crystallized at 200° C. for 12 h, cooled to room temperature after the crystallization was ended, and filtered to obtain a precipitated product.
(4) The resultant product was washed with water for 3 times, dried at 80° C. for 24 h, and then roasted at 550° C. for 6 h, and the product was weighed.

### Example 4

1. Synthesis of a seed:
(1) into a beaker firstly added were ethyl orthosilicate, tetrapropylammonium hydroxide and water according to a molar ratio (25:9:480), wherein firstly tetrapropylammonium hydroxide and water were added, stirred for 0.5 h, and then added with ethyl orthosilicate. It was stirred for 12 h, put into a kettle, and reacted at 100° C. for 4 d.
(2) The product after the reaction was centrifugally separated for about 10 min, the supernatant was discarded, the remaining solid was continually added with deionized water, subjected to ultrasonication for 10 min and centrifugally separated, and the supernatant was discarded. Washing was conducted in this way for 3-4 times until the pH of the supernatant was between 7-8, so as to obtain a solid as a seed. The solid could be oven-dried at 60° C. and ground.
2. Compounding:
(1) 2.5 ml of a 20 wt % polydiallyldimethylammonium chloride solution was taken and diluted into a 100 ml volumetric flask to formulate a 0.5 wt % solution. 20 ml of the solution was taken, added with 1 g of a silicon dioxide carrier, stirred for 1 h, and allowed to stand for 30 min. It was washed with water for 3-4 times, and centrifuged for 10 min after each time of washing.
(2) 0.05 g of the molecular sieve seed was weighed, added with 20 ml of an ammonia water solution with a pH of 9.5 to formulate a zeolite sol, added with the aforementioned carrier, stirred for 1 h, and allowed to stand for 30 min. 250 ml of a 0.1 mol/L ammonia water solution was formulated as a washing liquid to wash for 3-4 times, and centrifugation was conducted for 10 min after each time of washing.
(3) A secondary growth solution (m_{seed}/mSiO₂₋ₘᵢₓ=4 wt %) with a molar ratio of 0.056 Al₂(SO₄)₃:100 SiO₂:56 NaOH:4,000 H₂O was formulated, wherein a sodium hydroxide solution was firstly added with aluminum sulfate, then added with a silica sol (ludox AS-40) and stirred for 15 min, subsequently added with the aforementioned carrier preloaded with the seed, stirred at room temperature for 3 h, put into a kettle and crystallized at 200° C. for 12 h, cooled to room temperature after the crystallization was ended, and filtered to obtain a precipitated product.
(4) The resultant product was washed with water for 3 times, dried at 80° C. for 24 h, and then roasted at 550° C. for 6 h, and the product was weighed.

### Example 5

1. Synthesis of a seed:
(1) into a beaker firstly added were ethyl orthosilicate, tetrapropylammonium hydroxide and water according to a molar ratio (25:9:480), wherein firstly tetrapropylammonium hydroxide and water were added, stirred for 0.5 h, and then added with ethyl orthosilicate. It was stirred for 12 h, put into a kettle, and reacted at 100° C. for 4 d.
(2) The product after the reaction was centrifugally separated for about 10 min, the supernatant was discarded, the remaining solid was continually added with deionized water, subjected to ultrasonication for 10 min and centrifugally separated, and the supernatant was discarded. Washing was conducted in this way for 3-4 times until the pH of the supernatant was between 7-8, so as to obtain a solid as a seed. The solid could be oven-dried at 60° C. and ground.
2. Compounding:
(1) 2.5 ml of a 20 wt % polydiallyldimethylammonium chloride solution was taken and diluted into a 100 ml volumetric flask to formulate a 0.5 wt % solution. 20 ml of the solution was taken, added with 1 g of a silicon dioxide carrier, stirred for 1 h, and allowed to stand for 30 min. It was washed with water for 3-4 times, and centrifuged for 10 min after each time of washing.
(2) 0.05 g of the molecular sieve seed was weighed, added with 20 ml of an ammonia water solution with a pH of 9.5 to formulate a zeolite sol, added with the aforementioned carrier, stirred for 1 h, and allowed to stand for 30 min. 250 ml of a 0.1 mol/L ammonia water solution was formulated as a washing liquid to wash for 3-4 times, and centrifugation was conducted for 10 min after each time of washing.
(3) A secondary growth solution (m_{seed}/mSiO₂₋ₘᵢₓ=4 wt %) with a molar ratio of 0 Al₂(SO₄)₃: 100 SiO₂:56 NaOH:4,000 H₂O was formulated, wherein a sodium hydroxide solution was firstly added with aluminum sulfate, then added with a silica sol (ludox AS-40) and stirred for 15 min, subsequently added with the aforementioned carrier preloaded with the seed, stirred at room temperature for 3 h, put into a kettle and crystallized at 200° C. for 12 h, cooled to room temperature after the crystallization was ended, and filtered to obtain a precipitated product.
(4) The resultant product was washed with water for 3 times, dried at 80° C. for 24 h, and then roasted at 550° C. for 6 h, and the product was weighed.

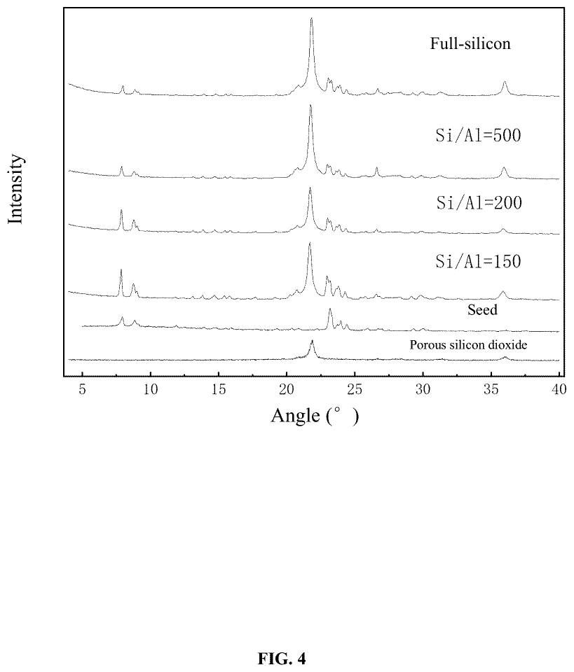

As shown in FIG. 4, the X-ray diffraction pattern of the porous silicon dioxide, the seed and the composite ZSM-5 molecular sieves with Si/Al=150, 200 and 500 and with full silicon, as carriers were shown from bottom to top, from which figure it could be known that the diffraction peaks occurred at 21-22° and 35-37° belonged to the carrier. The seed sample showed relatively strong diffraction peaks at about 8.2°, 9.1°, 23.4°, 24.3° and 24.8°. Through comparison with a standard spectrum, it was found that these 7 diffraction peaks all belonged to the crystallographic plane characteristic peaks of the ZSM-5 molecular sieve. Composite molecular sieves with different silicon-aluminum ratios all had the characteristic diffraction peaks of the carriers and the molecular sieves, and the present disclosure successfully prepared composite ZSM-5 molecular sieves with different silicon-aluminum ratios by adjusting the dosages of silicon sources and aluminum sources in the precursor growth solution.

Therefore, in the present disclosure, porous silicon dioxide is used as a carrier on a surface of which a nano zeolite seed is loaded, and then subjected to treatment with a secondary growth compound fluid and hydrothermal crystallization, so that a nano zeolite molecular sieve membrane is further grown on the surface of the porous silicon dioxide. The specific surface area and pore volume of the hierarchical porous material for the molecular sieve with the MFI structure prepared by the present disclosure are greatly improved compared with those of the original porous silicon dioxide. The material not only has the macroporous structure of the porous silicon dioxide, but also incorporates micropores of the molecular sieve itself and mesopores formed by molecular sieve agglomeration.

The above is only a specific embodiment of the present disclosure, but the scope of the present disclosure is not limited thereto, and changes or substitutions can easily come into the mind of those skilled in the art within the technical scope disclosed by the present disclosure. These changes or substitutions shall fall into the claimed scope of the present disclosure. Therefore, the claimed scope of the present disclosure should be determined by the claimed scope of the appended claims.

What is claimed is:

1. A method for preparing a hierarchical porous material for a molecular sieve with an MFI (Mordenite Framework Inverted) structure, comprising the following steps:
(1) synthesis of a molecular sieve seed:
(1-1) adding tetrapropylammonium hydroxide into water, stirring, then adding ethyl orthosilicate, stirring, and reacting at 90-110° C. for 3-5 days, wherein the molar ratio of the ethyl orthosilicate, the tetrapropylammonium hydroxide and the water is (20-30):(5-13):(450-510); and
(1-2) cleaning a reactant obtained in the step (1-1), oven-drying and grinding to obtain a molecular sieve seed; and
(2) compounding:
(2-1) adding porous silicon dioxide into a polycationic electrolyte solution with a concentration of 0.5 wt %, stirring and allowing to stand; washing with water for 3-4 times, and centrifugally separating after each times of washing, so as to obtain a porous silicon dioxide solution;
(2-2) adding the molecular sieve seed into an ammonia water solution with a pH of 9.5 to formulate a zeolite-ammonia water sol of 0.25 wt %-1 wt %, adding the porous silicon dioxide solution obtained in the step (2-1), stirring, and then allowing to stand; washing for 3-4 times, centrifugally separating after each times of washing, so as to obtain a carrier preloaded with the seed;
(2-3) formulating a secondary growth solution with a Al₂(SO₄)₃:SiO₂:NaOH:H₂O molar ratio of (0.03-2.50):100:(48-56):4,000, adding the carrier preloaded with the seed obtained in the step (2-2), stirring, putting into a reaction kettle, crystallizing at 180-220° C. for 3-8 h, cooling to normal temperature after the crystallization is ended, and filtering to obtain a precipitated product; and
(2-4) washing the precipitated product with water, and drying and roasting the product to obtain the hierarchical porous material for the molecular sieve with the MFI structure.

2. The preparation method of a hierarchical porous material for a molecular sieve with a MFI structure according to claim 1, wherein in the step (2-1), a concentration of the porous silicon dioxide solution is 4-6 g/ml.

3. The preparation method of a hierarchical porous material for a molecular sieve with a MFI structure according to claim 1, wherein in the step (2-3), a proportion of the carrier preloaded with the seed to the secondary growth solution is 3-5 wt %.

4. The preparation method of a hierarchical porous material for a molecular sieve with a MFI structure according to claim 1, wherein in the step (2-1), the polycationic electrolyte solution is an aqueous solution of polydiallyldimethylammonium chloride.

5. The preparation method of a hierarchical porous material for a molecular sieve with a MFI structure according to claim 1, wherein specific steps of the step (1-2) are:
centrifugally separating the reactant obtained in the step (1-1), discarding the supernatant, continually adding deionized water into the remaining solid, centrifugally separating after ultrasonication, and discarding the supernatant; repeatedly washing until the pH of the supernatant is 7-8, oven-drying the obtained solid at 60° C., and grinding to obtain the molecular sieve seed.

6. The preparation method of a hierarchical porous material for a molecular sieve with a MFI structure according to claim 1, wherein specific steps of the step (2-4) are: washing the precipitated product with water for 3 times, drying at 80° C. for 24 h, and then roasting at 550° C. for 6 h to obtain the hierarchical porous material for the molecular sieve with the MFI structure.

7. The preparation method of a hierarchical porous material for a molecular sieve with a MFI structure according to claim 1, wherein the used SiO₂ is a ludox AS-40 silica sol.

8. The preparation method of a hierarchical porous material for a molecular sieve with a MFI structure according to claim 1, wherein in the step (2-2), washing is conducted with a 0.1 mol/L ammonia water solution as a washing liquid for 3-4 times, and centrifugal separation is conducted after each time of washing.

9. A hierarchical porous material for a molecular sieve with a MFI structure prepared by the preparation method according to claim 1.
